(19) United States
(12) Patent Application Publication
(10) Pub. No.: US 2010/0270267 A1
(43) Pub. Date: Oct. 28, 2010

(54) ELECTRODE CONTACT MEMBER OF VACUUM CIRCUIT BREAKERS AND A METHOD OF MANUFACTURING THE SAME

(75) Inventor: Yasushi Noda, Fuji (JP)

Correspondence Address: BRUNDIDGE & STANGER, P.C., 2318 MILL ROAD, SUITE 1020, ALEXANDRIA, VA, 22314, US

(73) Assignee: JAPAN AE POWER SYSTEMS CORPORATION, Tokyo (JP)

(21) Appl. No.: 12/810,329

(22) PCT Filed: Oct. 27, 2008
(86) PCT No.: PCT/JP2008/069840

§ 371 Date: Jun. 24, 2010

(30) Foreign Application Priority Data
Dec. 26, 2007 (JP) 2007-333383

(51) Int. Cl. H01H 33/664; H01H 11/04

(52) U.S. Cl. 218/123; 29/622

(57) ABSTRACT

The contact member has a finely-dispersed Cr layer 2 having a thickness between 500 μm and 3 mm formed on the surface of a Cu—Cr alloy base material 1 through surface treatment by friction stir processing. The Cu—Cr alloy base material 1 contains 40 to 80 wt-% of Cu and 20 to 60 wt-% of Cr. The surface of the finely-dispersed Cr layer 2 is planarized after the surface treatment.

### TECHNICAL FIELD

The present invention relates to an electrode contact member of vacuum circuit breakers and a method of manufacturing the same. More particularly, the invention relates to an electrode contact member of vacuum circuit breakers that improves interruption performance preventing lowering in the withstand voltage property with the manufacturing of the same eased and relates to a method of manufacturing the same.

### BACKGROUND ART

As illustrated in FIG. 4, a vacuum circuit breaker 10 usually includes a hollow member 11 having an approximately cylindrical shape made of insulative material such as ceramic, metallic sealing members 12 and 13, and end plates 14 and 15 made of metal. And, the end plates 14 and 15 are fixed respectively on the each end of the hollow member 11 severally sandwiching metallic sealing members 12 and 13 between them to form an insulating chamber, the inside of which is vacuated to form an interruption chamber of vacuum atmosphere.

Inside the interruption chamber, there are arrangements such that a fixed-side current conveying conductor 16 is provided penetrating the endplate 14 and fixed hermetically therewith and such that a moving-side current conveying conductor 17 is provided penetrating the end plate 15. These current conveying conductors 16 and 17 have electrodes that confront each other in the interruption chamber.

Each of the electrodes include, as illustrated in FIG. 4 for example, coil electrodes 19A and 20A having circular-arc shaped grooves that are the means for generating magnetic field to drive arc, and electrode contact members 19B and 20B each of which is anchored on the end face of the coil electrodes 19A and 20A respectively.

The moving-side current conveying conductor 17 is arranged so that one end of which is hermetically sealed by a bellows 18 and is movably arranged to permit its movement in axial direction driven by an operating mechanism (not illustrated). And, one end of the bellows 18 is fixed on the end plate 15 and the other end thereof is fixed on the moving-side current conveying conductor 17. Further, cylindrical shields 21 and 22 are arranged to protect inner surface of the hollow member 11 and surface of the bellows 18 for prevention of adverse effect thereon caused by arcing between the electrode contacts 19B and 20B, or other potential places when current interruption operated by the operating mechanism.

The electrode contacts 19B and 20B anchored on the mutually confronting faces of the coil electrodes 19A and 20A have a large influence on performance of the vacuum circuit breaker 10 in that a circuit breaker should provide satisfactory current interruption properties covering from large current down to small current, high dielectric strength, excellent welding resistivity, etc. Because of this, there have been offered various materials and manufacturing methods for electrode contact members typically such as the electrode contact members 19B and 20B.

For example, Publication of Japanese Translation of PCT International Publication for Patent Application, JP04-505986A (Patent Literature 1) describes a sintered copper (Cu)—chromium (Cr) alloy. The sintered Cu—Cr alloy described in the literature is obtained by pressing powdered mixture of Cu as a material having good conductivity and Cr as an arc resistive component mixed in a proper mixing ratio followed by sintering in vacuum atmosphere. The sintered Cu—Cr alloy thus obtained undergoes cold working to form an electrode contact member of a vacuum circuit breaker to be put in a practical use.

Publication of Unexamined Japanese Patent Application, JP04-95318A (Patent Literature 2) describes a Cu—Cr alloy powder as a material for an electrode contact member of vacuum circuit breakers. The Cu—Cr alloy powder has an average grain size of 150 μm or smaller and includes Cr having an average grain size of 5 μm or smaller. This Cu—Cr alloy powder is obtained through mixing powdered Cu and Cr, melting the mixture to a molten metal in inert gas atmosphere or in vacuum, micronizing the molten metal by atomization method, and dispersing the micronized molten metal into Cu base material. The literature further describes an improvement in current interruption property and contact welding resistivity by sintering the Cu—Cr alloy powder thus obtained to bring the average grain size of Or between 2 and 20 μm.

Further, Publication of Unexamined Japanese Patent Application, JP04-312723A (Patent Literature 3) describes a method of manufacturing a contact for a vacuum circuit breaker that improves current shutoff property. The literature describes such a method that the entire surface of contact formed using: a laminate of Cu plate and Cr plate, a laminate of Cu plate and Cr grains, a mixture or a mold of Cu grains and Cr grains, or Cu—Cr alloy, is irradiated by a high-energy density laser beam with a predetermined rate of irradiation overlap to give a sharp thermal history having a very high peak temperature. Thereby, minute Cr grains of 0.1 to 5 μm in size are allowed to exist in the Cu phase in the region from the irradiated surface of the Cu—Cr alloy to a depth of about 50 μm with the occurrence provability of resignation reduced. (Refer to Patent literature 3 for details.)

Additionally further, Publication of Unexamined Japanese Patent Application, JP11-229057A (Patent Literature 4) describes an application of a laminated composite material to a contact member of a vacuum circuit breaker. The described laminated composite material has a first layer composed of Cu or Cu alloy and a second layer composed of Cu—Cr series composite material bonded to the first layer. Thereby, high performances in electrical conductivity, thermal conductivity, heat resistivity, and further arc resistivity are given to the contact member. (Refer to Patent Literature 4 for details.)

### DISCLOSURE OF INVENTION

### [Technical Problem]

As stated above, it has been known that an electrode contact member of a vacuum circuit breaker improves its performances in the withstand voltage and interruption when the grain size of Cr in the sintered alloy base material used therein is minute and the texture or structure is uniform. However, in manufacturing sintered alloy base material by solid phase sintering with an ordinary manner as described in the patent literatures listed above, oxidation progresses to undesirable extent making sintering hard to proceed with oxygen content increased when the grain size of Cr powder is about 10 μm resulting in the performance of a vacuum circuit breaker being lowered.

An electrode contact member of Cu—Cr alloy manufactured by such as vacuum arc melting method as described in Patent Literature 2 exhibits good performances in withstand voltage and interruption since the alloy has a fine and uniform texture. However, conductivity of such alloy is so low that the electrode contact member of a vacuum circuit breaker is made have a high contact resistance. Moreover, the vacuum arc melting method has disadvantage in that the method is an expensive technique and poor in productivity.

In vacuum circuit breakers of operating voltage rating of 36 kV or over, a method that forms a finely-dispersed Cr layer on the surface of an electrode contact member by generating current-arc thereon followed by rapid cooling (electrical current forming method) is also employed. The electrical current forming method needs a repeated application of arc treatment for several times to produce a uniform layer on the surface of contact member. Further, the method has an disadvantage in that metal vapor produced by arc during treatment contaminates inner face of a ceramic container that forms the insulating chamber of a vacuum circuit breaker with the lifetime of the vacuum circuit breaker shortened. Moreover, the method has such a limit that the formable thickness is 10 to 20 μm in forming the finely-dispersed Cr layer. Therefore, the electrode contact member used in a vacuum circuit breaker of the operating voltage rating of 72 kV or over has encountered an improvement-demanding problem of significant lowering in withstand voltage property as the number of open/close operations increases.

The object of the present invention is to provide an electrode contact member of a vacuum circuit breaker that improves withstand voltage performance and interruption performance by forming a finely-dispersed Cr layer on the surface of a Cu—Cr alloy base material in a thickness between 500 μm and 3 mm.

Another object of the present invention is to provide a method for manufacturing an easily manufacturable electrode contact member of a vacuum circuit breaker. The method forms with ease a thick finely-dispersed Cr layer on the surface of Cu—Cr alloy base material having a thickness between 500 μm and 3 mm.

### [Solution to Problem]

An electrode contact member according to the present invention used being anchored on each of the electrodes confronting each other in an interruption chamber of vacuum atmosphere. And, the contact member has a finely-dispersed Cr layer having a thickness between 500 μm and 3 mm formed on the surface of a Cu—Cr alloy base material through surface treatment by friction stir processing. The Cu—Cr alloy base material contains 40 to 80 wt-% of Cu and 20 to 60 wt-% of Cr.

Preferably, the size of Cr grain in the finely-dispersed Cr layer is smaller than the size of Cr grain in the Cu—Cr alloy base material. More preferably, the size of Cr grain in the finely-dispersed Cr layer is between 0.1 and 10 μm.

The method for manufacturing an electrode contact member of a vacuum circuit breaker according to the present invention includes: the step of using Cu—Cr alloy base material containing 40 to 80 wt-% of Cu and 20 to 60 wt-% of Cr; the step of forming a finely-dispersed Cr layer of a thickness between 500 μm and 3 mm on the surface of the Cu—Cr alloy base material through surface treatment by friction stir processing; and the step of planarizing the surface of the finely-dispersed Cr layer.

### [Effect of Invention]

The electrode contact member of a vacuum circuit breaker according to the present invention is useful particularly for use in high-voltage vacuum circuit breakers of a voltage rating of 72 kV or over. This is because that the electrode contact member prevents lowering in the withstand voltage performance since the finely-dispersed Cr layer is formed in a thickness between 500 μm and 3 mm on the surface of the Cu—Cr alloy base material by friction stir processing. Further, the layer constitution improves interruption performance of an electrode contact member and has an advantage of repressing increase in contact resistance because of the Cu—Cr alloy base material having a good conductivity.

The method for manufacturing an electrode contact member of a vacuum circuit breaker according to the present invention is suitable for a mass production of electrode contact members for vacuum circuit breakers. This is because that the finely-dispersed Cr layer can be easily formed in a thickness between 500 μm and 3 mm on the surface of the Cu—Cr alloy base material through surface treatment by friction stir processing and that working is easy.

### BRIEF DESCRIPTION OF DRAWINGS

FIG. 1 is a sectional view of the electrode contact member of a vacuum circuit breaker in an embodiment of the present invention.

FIG. 2 is a characteristics graph showing the relationship between the number of open/close operations and withstand voltage obtained from a small capacitive current switching test performed on a vacuum circuit breaker with different thicknesses of the finely-dispersed Cr layer of the electrode contact member thereof.

FIGS. 3(a) to 3(c) are simplified illustrations for explanation of processes in the manufacturing of the electrode contact of a vacuum circuit breaker in an embodiment of the present invention.

FIG. 4 is an approximate vertical sectional view of a conventional vacuum circuit breaker.

### BEST MODE FOR CARRYING OUT THE INVENTION

### Embodiment

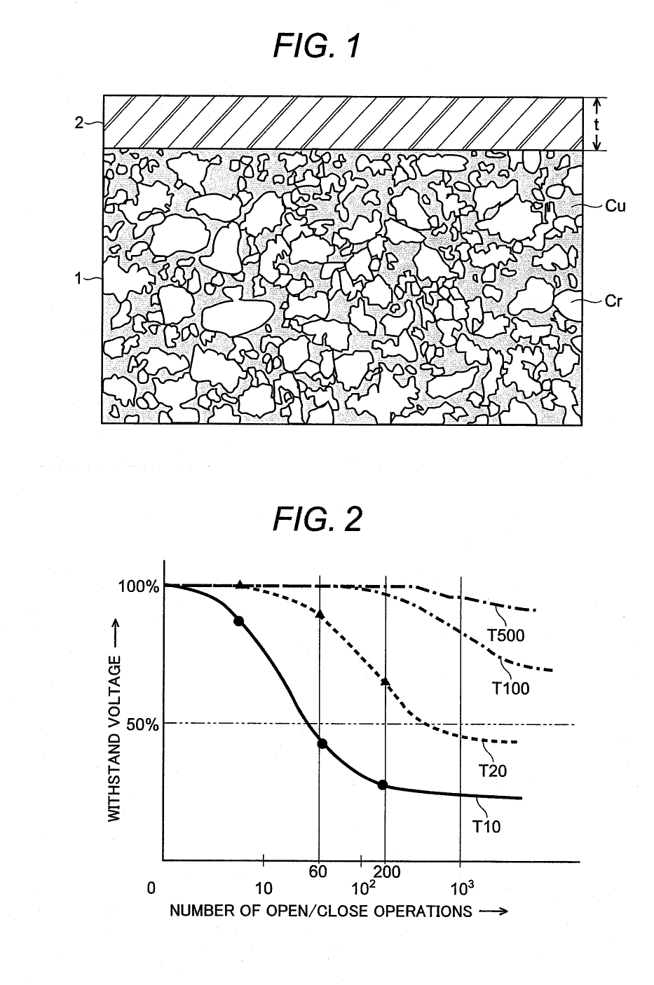

An electrode contact member of a vacuum circuit breaker according to the present invention is illustrated in FIG. 1. The electrode contact member is formed in a 2-layer structure composed of a Cu—Cr alloy base material 1 and a finely-dispersed Cr layer 2. The Cu—Cr alloy base material 1 uses a sintered Cu—Cr alloy base material obtained through processes of: mixing powdered Cu and Cr in a specified ratio, sintering the mixture in non-oxygen atmosphere such as vacuum or inert gas, and pressing the sintered mixture to make grains in the mixture to be coherent each other. Alternatively, the Cu—Cr alloy base material 1 uses a Cu—Cr alloy base material obtained by melting Cu and Cr in a predetermined ratio in vacuum.

The Cu—Cr alloy base material 1 is not able to improve interruption performance nor prevent lowering in the withstand voltage performance if Cr content rate is smaller than 20 wt-%. Further, when the Cr content rate is over 60 wt-%, such rate invites lowered conductivity connecting to higher resistance, which causes the electrode contact member being highly-heated with possible deterioration of constituent material. Therefore, the rates of Cu and Cr in the Cu—Cr alloy base material 1 are preferred to be 40 to 80 wt-% and 20 to 60 wt-% respectively. It may be practicable to add metallic additives, as a well-known practice, such as bismuth (bi), tellurium (Te), antimony (Sb), and niobium (Nb) to these constituent Cu and Cr depending on needs.

The finely-dispersed Cr layer 2 formed on the surface of the Cu—Cr alloy base material 1 is to have the thickness t of 500 μm or more, preferably 500 μm to 3 mm. The forming of the finely-dispersed Cr layer 2 uses the friction stir welding process, a method for joining metallic plates (refer to for example, SOSEI-TO-KAKOU, Vol. 43 No. 498, (2002-7), Journal of Japan Society for Technology of Plasticity). The finely-dispersed Cr layer 2 according to the present invention is formed by softening the Cu—Cr alloy base material 1 applying the friction stir welding process. In the processing, the tip of a rotating tool is held against the surface of the Cu—Cr alloy base material 1 and is rotated to soften it by frictional heat and processing heat generated by the rotation.

The grain size of the fine particle of Cr, the constituent of the finely-dispersed Cr layer 2, is made less than 10 μm, which is smaller than the grain size of the Cu—Cr alloy base material 1. Preferably, the grain size of the fine particle of Cr should be controlled to be 0.1 to 10 μm.

Forming the electrode contact member in a 2-layer structure composed of Cu—Cr alloy base material 1 and a finely-dispersed Cr layer 2 and, moreover, making the thickness of the finely-dispersed Cr layer 2 be 500 μm to 3 mm repress such a tendency that a vacuum circuit breaker lowers its withstand voltage performance as the number of open/close operations increases.

Regarding this feature, detailed explanation follows referring to FIG. 2. FIG. 2 is a characteristics graph obtained from a small capacitive current switching test performed on the vacuum circuit breaker of a voltage rating of 72 kV with a making current of 1 kAP and a breaking current of 200 A rms in the switching operation of a capacitor bank. As indicated in FIG. 2, the withstand voltage behaved in the test as the characteristic curves T10 to T500 indicated corresponding to the variation of the thickness t of the finely-dispersed Cr layer of the electrode contact member being 10, 20, 100, and 500 μm.

For the cases of electrode contact members having the finely-dispersed Cr layer of 10 and 20 μm in thickness t, the withstand voltage went down soon after the switching test began. Particularly, the withstand voltage lowered to the half of the initial value: when the number of open/close operations reached 60 times, where the thickness was 10 μm as the characteristics curve T10 showed, and when exceeded 500 times, where thickness 20 μm as T20 showed. Further, even when the thickness t of the finely-dispersed Cr layer was 100 μm, the lowering had begun already when the number of open/close operations reached about 100 times as the characteristics curve T100 showed.

In contrast to this, the lowering in the withstand voltage occurs significantly later number of times as the characteristics curve T500 shows in the case of an electrode contact member having the finely-dispersed Cr layer of 500 μm in thickness t as the present invention defines. Moreover, the lowering in the withstand voltage is repressed within a little extent even when the number of open/close operations exceeds 1000 times.

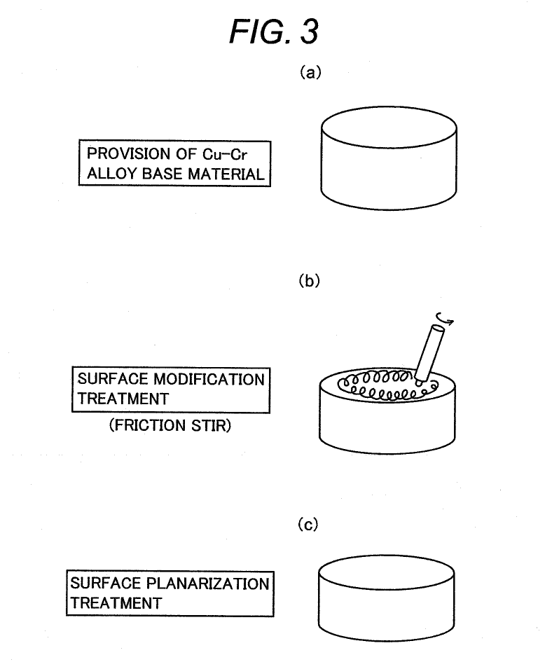

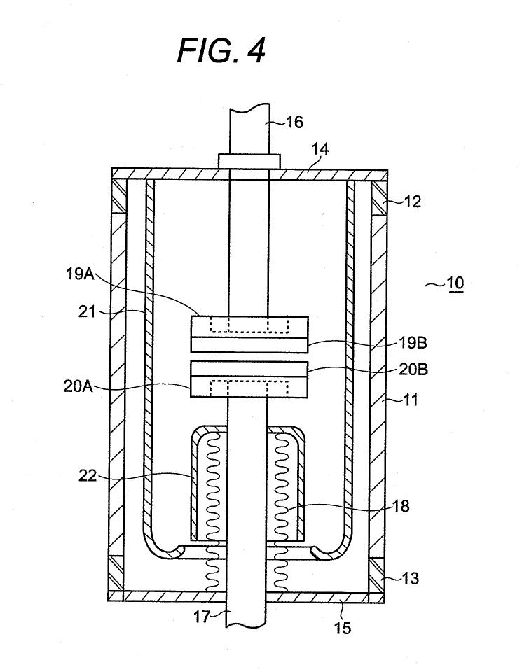

The electrode contact member of a vacuum circuit breaker according to the present invention is manufactured in a 2-layer structure by a method includes the steps as illustrated in FIGS. 3(a) to 3(c) for example. First, a Cu—Cr alloy base material is formed as illustrated in FIG. 3(a). Then, the tip of a rotating tool called a stir rod is held against the surface of the Cu—Cr alloy base material in a manner similar to that which the friction stir welding would employ as illustrated in FIG. 3(b). The rotating tool thus held is rotated so that the base material is stirred frictionally producing frictional heat and processing heat therein to soften the surface thereof with the finely-dispersed Cr layer formed thereon.

Lastly, the surface of the finely-dispersed Cr layer thus formed on the Cu—Cr alloy base material is planarized as illustrated in FIG. 3(c), by a mechanical treatment for example. Where necessary, spiral grooves are formed on the planarized surface to drive arc, likewise in ordinary electrodes. The electrode contact member thus formed is then anchored on a coil electrode with the Cu—Cr alloy base material side adjoined the coil electrode, and is used being installed in a manner that the face of the finely-dispersed Cr layer confronts each other.

As stated above, manufacturing the electrode contact member of a vacuum circuit breaker in a 2-layer structure of a Cu—Cr alloy base material and a finely-dispersed Cr layer by the friction stir processing easily attains a thickness of about 500 μm to about 3 mm with the finely-dispersed Cr layer. Moreover, such manufacturing process makes it easy to manufacture the electrode contact members in quantity.

### INDUSTRIAL APPLICABILITY

An electrode contact member of a vacuum circuit breaker according to the present invention prevents lowering in the withstand voltage performance of the vacuum circuit breaker. And, the electrode contact member is useful particularly for high-voltage vacuum circuit breakers of voltage rating of 72 kV or over since a finely-dispersed Cr layer is formed in a thickness between 500 μm and 3 mm on the surface of the Cu—Cr alloy base material by the friction stir processing. A method for manufacturing the electrode contact member according to the present invention is suitable for the mass production of electrode contact members of vacuum circuit breakers since the method easily forms a finely-dispersed Cr layer in a simple manner of processing.

1. An electrode contact member of a vacuum circuit breaker, the electrode contact member being used confronting each other in an interruption chamber of vacuum atmosphere, wherein the electrode contact member has a finely-dispersed Cr layer having a thickness between 500 μm and 3 mm formed on the surface of a Cu—Cr alloy base material through surface treatment by friction stir processing, the Cu—Cr alloy base material containing 40 to 80 wt-% of Cu and 20 to 60 wt-% of Cr.

2. The electrode contact member of a vacuum circuit breaker according to claim 1, wherein the size of Cr grain in the finely-dispersed Cr layer is smaller than the size of Cr grain in the Cu—Cr alloy base material.

3. The electrode contact member of a vacuum circuit breaker according to claim 1, wherein the size of Cr grain in the finely-dispersed Cr layer is between 0.1 and 10 μm.

4. A method for manufacturing an electrode contact member of a vacuum circuit breaker comprising: forming a Cu—Cr alloy base material containing 40 to 80 wt-% of Cu and 20 to 60 wt-% of Cr; forming a finely-dispersed Cr layer of a thickness between 500 μm and 3 mm on the surface of the Cu—Cr alloy base material through surface treatment by friction stir processing; and planarizing the surface of the finely-dispersed Cr layer.
